(19) United States
(12) Patent Application Publication
(10) Pub. No.: US 2014/0281447 A1
(43) Pub. Date: Sep. 18, 2014

(54) Single-Chip Virtualizing and Obfuscating Communications System for Portable Computing Devices

(71) Applicant: Green Hills Software, Inc., Santa Barbara, CA (US)

(72) Inventors: David Noah Kleidermacher, Santa Barbara, CA (US); Daniel Jonathan Hettena, Princeton, NJ (US); Dennis Chang Kou, Goleta, CA (US)

(73) Assignee: Green Hills Software, Inc., Santa Barbara, CA (US)

(21) Appl. No.: 14/205,397

(22) Filed: Mar. 12, 2014

Related U.S. Application Data
(60) Provisional application No. 61/778,375, filed on Mar. 12, 2013.

(51) Int. Cl. H04L 29/06; G06F 21/57

(52) U.S. Cl. CPC H04L 63/0823; G06F 21/575
USPC 713/1; 713/156

(57) ABSTRACT

A virtualizing and obfuscating communications firmware module may be incorporated into common, mass-market portable computing devices, such as smartphones and tablets, to provide this service. The disclosure encompasses authentication and obfuscation software components that may comprise trusted firmware whose operation is protected from the main portable device operating system that is assumed to be hostile (e.g. infiltrated with malware or under the control of a remote attacker). In certain embodiments, a single-chip design is disclosed, without any specialized hardware: only the primary portable device applications microprocessor may be used by both the main operating system and the virtualizing and obfuscating communications firmware module. The operating system may operates as if it has access to a real communications peripheral, but in reality the virtualizing and obfuscating communications firmware module virtualizes this peripheral. The firmware module may perform authentication of the user and obfuscation of the data without the operating system's knowledge.

### CROSS REFERENCE TO RELATED APPLICATION

This application claims priority to U.S. Provisional Patent Application No. 61/778,375, filed Mar. 12, 2013, which is incorporated by reference herein in its entirety.

### 1. FIELD OF THE DISCLOSURE

The disclosure relates generally to methods for obfuscating information for portable computing devices; and more particularly to information-in-transit protection for portable computing systems.

### 2. GENERAL BACKGROUND

Information-in-transit protection is important for portable computing systems (such as smartphones) because information obfuscation prevents an attacker from reading the sensitive data as it is transmitted or received between the portable computing system and remote communications endpoints such as a computer within a corporate network. In portable computing devices, VPN client applications hosted by the device's primary operating system are a popular choice to implement obfuscated communications. For example, Apple OSX Lion and iOS incorporate communications encryption technology, as does Google Android. The problem with incorporating communications encryption into the portable device operating system is that these operating systems are extremely sophisticated and prone to vulnerabilities. Every popular portable device operating system suffers from serious vulnerabilities that enable malware and hackers to obtain “root” access which can then defeat the communications encryption layer, for example by stealing the encryption key or bypassing the encryption service.

Accordingly, it is desirable to address the limitations in the art.

### BRIEF DESCRIPTION OF THE DRAWINGS

By way of example, reference will now be made to the accompanying drawings, which are not to scale.

FIG. 1 illustrates an exemplary networked environment and its relevant components according to certain embodiments of the present invention.

FIG. 2 is an exemplary block diagram of a computing device that may be used to implement aspects of certain embodiments of the present invention.

FIG. 3 illustrates an overview of a portable computing device, configured with a virtualizing and obfuscating storage firmware module in accordance with certain embodiments.

### DETAILED DESCRIPTION

Those of ordinary skill in the art will realize that the following description of the present invention is illustrative only and not in any way limiting. Other embodiments of the invention will readily suggest themselves to such skilled persons, having the benefit of this disclosure. Reference will now be made in detail to specific implementations of the present invention as illustrated in the accompanying drawings. The same reference numbers will be used throughout the drawings and the following description to refer to the same or like parts.

Further, certain figures in this specification are flow charts illustrating methods and systems. It will be understood that each block of these flow charts, and combinations of blocks in these flow charts, may be implemented by computer program instructions. These computer program instructions may be loaded onto a computer or other programmable apparatus to produce a machine, such that the instructions which execute on the computer or other programmable apparatus create structures for implementing the functions specified in the flow chart block or blocks. These computer program instructions may also be stored in a computer-readable memory that can direct a computer or other programmable apparatus to function in a particular manner, such that the instructions stored in the computer-readable memory produce an article of manufacture including instruction structures which implement the function specified in the flow chart block or blocks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart block or blocks.

Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems which perform the specified functions or steps, or combinations of special purpose hardware and computer instructions.

For example, any number of computer programming languages, such as C, C++, C# (CSharp), Perl, Ada, Python, Pascal, SmallTalk, FORTRAN, assembly language, and the like, may be used to implement aspects of the present invention. Further, various programming approaches such as procedural, object-oriented or artificial intelligence techniques may be employed, depending on the requirements of each particular implementation. Compiler programs and/or virtual machine programs executed by computer systems generally translate higher level programming languages to generate sets of machine instructions that may be executed by one or more processors to perform a programmed function or set of functions.

The term “machine-readable medium” should be understood to include any structure that participates in providing data which may be read by an element of a computer system. Such a medium may take many forms, including but not limited to, non-volatile media, volatile media, and transmission media. Non-volatile media include, for example, optical or magnetic disks and other persistent memory. Volatile media include dynamic random access memory (DRAM) and/or static random access memory (SRAM). Transmission media include cables, wires, and fibers, including the wires that comprise a system bus coupled to processor. Common forms of machine-readable media include, for example and without limitation, a floppy disk, a flexible disk, a hard disk, a magnetic tape, any other magnetic medium, a CD-ROM, a DVD, any other optical medium.

FIG. 1 depicts an exemplary networked environment 100 in which systems and methods, consistent with exemplary embodiments, may be implemented. As illustrated, networked environment 100 may include without limitation a content server 110, a receiver 120, and a network 130. The exemplary simplified number of content servers 110, receivers 120, and networks 130 illustrated in FIG. 1 can be modified as appropriate in a particular implementation. In practice, there may be additional content servers 110, receivers 120, and/or networks 130.

In certain embodiments, a receiver 120 may include without limitation any suitable form of multimedia playback device, including, without limitation, a cable or satellite television set-top box, a DVD player, a digital video recorder (DVR), or a digital audio/video stream receiver, decoder, and player. A receiver 120 may connect to network 130 via wired and/or wireless connections, and thereby communicate or become coupled with content server 110, either directly or indirectly. Alternatively, receiver 120 may be associated with content server 110 through any suitable tangible computer-readable media or data storage device (such as a disk drive, CD-ROM, DVD, or the like), data stream, file, or communication channel.

Network 130 may include without limitation one or more networks of any type, including a Public Land Mobile Network (PLMN), a telephone network (e.g., a Public Switched Telephone Network (PSTN) and/or a wireless network), a local area network (LAN), a metropolitan area network (MAN), a wide area network (WAN), an Internet Protocol Multimedia Subsystem (IMS) network, a private network, the Internet, an intranet, a cellular network and/or another type of suitable network, depending on the requirements of each particular implementation.

One or more components of networked environment 100 may perform one or more of the tasks described as being performed by one or more other components of networked environment 100.

FIG. 2 is an exemplary diagram of a computing device 200 that may be used to implement aspects of certain embodiments of the present invention, such as aspects of content server 110 or of receiver 120. In certain embodiments, computing device 200 may be a mobile computing device which may include without limitation a smart phone or tablet device. Computing device 200 may include without limitation a bus 201, one or more processors 205, a main memory 210, a read-only memory (ROM) 215, a storage device 220, one or more input devices 225, one or more output devices 230, and a communication interface 235. Bus 201 may include without limitation one or more conductors that permit communication among the components of computing device 200.

Processor 205 may include without limitation any type of conventional processor, microprocessor, or processing logic that interprets and executes instructions. Main memory 210 may include without limitation a random-access memory (RAM) or another type of dynamic storage device that stores information and instructions for execution by processor 205. ROM 215 may include without limitation a conventional ROM device or another type of static storage device that stores static information and instructions for use by processor 205. Storage device 220 may include without limitation a magnetic and/or optical recording medium and its corresponding drive.

Input device(s) 225 may include without limitation one or more conventional mechanisms that permit a user to input information to computing device 200, such as a keyboard, a mouse, a pen, a stylus, handwriting recognition, voice recognition, biometric mechanisms, touch screen and the like. Output device(s) 230 may include without limitation one or more conventional mechanisms that output information to the user, including a display, a projector, an A/V receiver, a printer, a speaker, and the like. Communication interface 235 may include without limitation any transceiver-like mechanism that enables computing device/server 200 to communicate with other devices and/or systems. For example, communication interface 235 may include without limitation mechanisms for communicating with another device or system via a network, such as network 130 as shown in FIG. 1.

As will be described in detail below, computing device 200 may perform operations based on software instructions that may be read into memory 210 from another computer-readable medium, such as data storage device 220, or from another device via communication interface 235. The software instructions contained in memory 210 cause processor 205 to perform processes that will be described later. Alternatively, hardwired circuitry may be used in place of or in combination with software instructions to implement processes consistent with the present invention. Thus, various implementations are not limited to any specific combination of hardware circuitry and software.

A web browser comprising a web browser user interface may be used to display information (such as textual and graphical information) on the computing device 200. The web browser may comprise any type of visual display capable of displaying information received via the network 130 shown in FIG. 1, such as Microsoft's Internet Explorer browser, Netscape's Navigator browser, Mozilla's Firefox browser, PalmSource's Web Browser, Google's Chrome browser or any other commercially available or customized browsing or other application software capable of communicating with network 130. The computing device 200 may also include a browser assistant. The browser assistant may include without limitation a plug-in, an applet, a dynamic link library (DLL), or a similar executable object or process. Further, the browser assistant may be a toolbar, software button, or menu that provides an extension to the web browser. Alternatively, the browser assistant may be a part of the web browser, in which case the browser would implement the functionality of the browser assistant.

The browser and/or the browser assistant may act as an intermediary between the user and the computing device 200 and/or the network 130. For example, source data or other information received from devices connected to the network 130 may be output via the browser. Also, both the browser and the browser assistant are capable of performing operations on the received source information prior to outputting the source information. Further, the browser and/or the browser assistant may receive user input and transmit the inputted data to devices connected to network 130.

Similarly, certain embodiments of the present invention described herein are discussed in the context of the global data communication network commonly referred to as the Internet. Those skilled in the art will realize that embodiments of the present invention may use any other suitable data communication network, including without limitation direct point-to-point data communication systems, dial-up networks, personal or corporate Intranets, proprietary networks, or combinations of any of these with or without connections to the Internet.

In the following description, certain embodiments of the method are described in terms of particular data structures, preferred and optional enforcements, preferred control flows, and examples. Other and further application of the described method, as would be understood after review of this application by those with ordinary skill in the art, are within the scope of the invention.

In certain embodiments, an information obfuscation service may be incorporated directly into the main applications processor of a portable computing device 300 such that the applications processor and its relevant communications peripherals 350 may be securely shared via a virtualization firmware module, avoiding the use of specialized hardware or major modifications of the main operating system 320. The virtualizing and obfuscating communications firmware module 340 may enable a much higher level of assurance in information-in-transit protection while using only the memory protection and privilege mode facilities inherent in common portable device applications microprocessors. The virtualizing and obfuscating communications firmware may interpose communications accesses originating from the main operating system 320. When the main operating system 320 attempts to write to communications peripherals, the virtualizing and obfuscating firmware module may intercept the write request, obfuscate the write data, and then write the obfuscated data to the physical communications media. When the main operating system 320 attempts to read from communications peripherals, the virtualizing and obfuscating firmware module may intercept the read request, read the data from the physical communications media, de-obfuscate the read data, and then forward the data to the main operating system 320. This interposition may be performed seamlessly, without explicit knowledge of the main operating system 320.

In certain embodiments, the virtualizing and obfuscating storage firmware may make creative use of the portable device's graphical display and inputs (e.g. touchscreen) to enable user authentication that unlocks the protected storage media for use by the main operating system 320. The firmware module may offer the user a mode of operation used for authentication that is distinct from the normal mode of operation using the main operating system's human-machine interface (HMI). These modes of operation and multiple uses of shared graphical and input peripherals 350 may be accomplished by virtualizing those peripherals 330 and using them to provide the user with a trusted indication regarding which mode is active.

Certain embodiments involve an information obfuscation service for portable computing devices 300. A virtualizing and obfuscating communications firmware module 340 may be incorporated into common, mass-market portable computing devices, such as smartphones and tablets, to provide this service. The disclosure encompasses authentication and obfuscation software components that may comprise trusted firmware whose operation is protected from the main portable device operating system 320 that is assumed to be hostile (e.g. infiltrated with malware or under the control of a remote attacker). In certain embodiments, a single-chip design is disclosed, without any specialized hardware: only the primary portable device applications microprocessor may be used by both the main operating system 320 and the virtualizing and obfuscating communications firmware module 340. The operating system 320 may operates as if it has access to a real communications peripheral, but in reality the virtualizing and obfuscating communications firmware module 340 virtualizes this peripheral. The firmware module may perform authentication of the user and obfuscation of the data without the operating system's knowledge. This may result in a virtualized information obfuscation system that is similar to an operating system VPN client but may be fully isolated from the platform operating system 320 and able to run on any communications medium without requiring any additional or specialized hardware.

In order to execute a trusted obfuscation service and a general-purpose operating system 320 on the same processor, some form of system and/or network virtualization may be needed. Examples of firmware implementations that provide a concurrently executing environment alongside, but securely separated from the main operating system 320, include without limitations hypervisors and Trusted Execution Environments (TEE). Obfuscation may be implemented using cryptographic encryption or other information hiding techniques. Because the obfuscation is executed within the trusted virtualizing and obfuscating communications firmware module 340, no other untrusted applications on the platform (including the main operating system 320 itself) may be able to access critical obfuscation components (such as a data encryption key).

In certain embodiments, a portable computing device 300 is disclosed comprising: at least one general-purpose operating system 320; at least one virtualized communications device 330 accessed by the operating system 320; at least one physical communications device 350 that cannot be directly accessed by the operating system 320; and at least one virtualizing and obfuscating firmware module executing concurrently with the operating system 320 on the same microprocessor. The virtualizing and obfuscating communications firmware module 340 may manifest the virtualized communications device 330 on behalf of the operating system 320 and may intercept communications transactions between the virtualized communications device 330 and physical communications device 350. The virtualization module may perform obfuscation services of data as it is transacted between the virtualized communications device 330 and physical communications device 350.

The virtualizing and obfuscating communications firmware module 340 may be launched by a secure boot sequence requiring a hardware root of trust. The virtualizing and obfuscating communications firmware module firmware image may be measured by the computing device hardware and/or its immutable firmware and may be verified to be valid by using pre-configured measurement parameters such as cryptographic keys and certificates within the portable device hardware prior to executing the virtualizing and obfuscating communications firmware module.

The virtualizing and obfuscating communications firmware module 340 may be implemented as one or more additional logical threads of execution that can be mapped to one or physical threads or cores, as is common in modern multi-core portable device applications processors. The use of these additional logical threads of execution may enable the virtualizing and obfuscating communications firmware module 340 to execute concurrently with other portions of the main operating system 320 in order to improve overall communications latency and system performance.

The virtualizing and obfuscating communications firmware module 340 may control and manage on-board portable device sensors (such as a Global Positioning Satellite peripheral) to enforce a policy in which the virtualized communications system is only made available when the sensor readings are within an acceptable range of values. The main operating system 320 may be unable to corrupt the sensor readings obtained by the virtualizing and obfuscating communications firmware module 340. Global Positioning Service, cellular signals, or other location-based services may be used to enforce the availability policy based on an acceptable selection of location values or ranges.

While the above description contains many specifics and certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art, as mentioned above. The invention includes any combination or subcombination of the elements from the different species and/or embodiments disclosed herein.

We claim:

1. A portable computing device, comprising:
at least one operating system;
at least one virtualized communications device configured to be accessed by the operating system;
at least one physical communications device configured not to be directly accessible by the operating system; and
at least one virtualizing and obfuscating firmware module configured for executing concurrently with the operating system on a processor.

2. The portable computing device of claim 1, wherein the virtualizing and obfuscating communications firmware module is configured to manifest the virtualized communications device on behalf of the operating system.

3. The portable computing device of claim 1, wherein the virtualizing and obfuscating communications firmware module is configured to intercept communications transactions between the at least one virtualized communications device and the at least one physical communications device.

4. The portable computing device of claim 1, wherein the virtualizing and obfuscating communications firmware module is configured to perform obfuscation services of data as it is transferred between the at least one virtualized communications device and that at least one physical communications device.

5. The portable computing device of claim 1, wherein the virtualizing and obfuscating communications firmware module is configured to be launched by a secure boot sequence requiring a hardware root of trust.

6. The portable computing device of claim 1, wherein the virtualizing and obfuscating communications firmware module is configured to be measured by hardware of the portable computing device.

7. The portable computing device of claim 1, wherein the virtualizing and obfuscating communications firmware module is configured to be measured by immutable firmware.

8. The portable computing device of claim 1, wherein the virtualizing and obfuscating communications firmware module is configured to be verified to be valid by using one or more measurement parameters.

9. The portable computing device of claim 8, wherein the one or more measurement parameters comprise at least one of a cryptographic key and a certificate within the portable device hardware.

10. The portable computing device of claim 1, wherein the virtualizing and obfuscating communications firmware module is configured to be verified to be valid prior to executing the virtualizing and obfuscating communications firmware module.

11. The portable computing device of claim 1, wherein the virtualizing and obfuscating communications firmware module comprises one or more additional logical threads of execution that can be mapped to one or physical threads or cores.

12. The portable computing device of claim 11, wherein the additional logical threads of execution enable the virtualizing and obfuscating communications firmware module to execute concurrently with other portions of the at least one operating system to improve overall communications latency and system performance.

13. The portable computing device of claim 1, wherein the virtualizing and obfuscating communications firmware module is configured to control and manage one or more sensors to enforce a policy in which the virtualized communications system is only made available when one or more sensor readings are within an acceptable range of values.

14. The portable computing device of claim 13, wherein one or more sensors comprise at least one Global Positioning Satellite peripheral.

15. The portable computing device of claim 13, wherein the one or more sensor readings obtained by the virtualizing and obfuscating communications firmware module are resistant to corruption by the main operating system.

16. The portable computing device of claim 13, wherein the one or more sensor readings are provided by at least one of a Global Positioning Service, a cellular signal, and another location-based services.

17. A method of information-in-transit protection, comprising:
configuring at least one virtualized communications device to be accessed by an operating system;
configuring at least one physical communications device not to be directly accessible by the operating system; and
configuring at least one virtualizing and obfuscating firmware module for executing concurrently with the operating system on a processor.

18. The method of claim 17, further comprising configuring the virtualizing and obfuscating communications firmware module to manifest the virtualized communications device on behalf of the operating system.

19. The method of claim 17, further comprising configuring the virtualizing and obfuscating communications firmware module to intercept communications transactions between the at least one virtualized communications device and the at least one physical communications device.

20. The method of claim 17, further comprising configuring the virtualizing and obfuscating communications firmware module to perform obfuscation services of data as it is transferred between the at least one virtualized communications device and the at least one physical communications device.

21. The method of claim 17, further comprising configuring the virtualizing and obfuscating communications firmware module to be launched by a secure boot sequence requiring a hardware root of trust.

22. The method of claim 17, further comprising configuring the virtualizing and obfuscating communications firmware module to be measured by hardware of the portable computing device.

23. The method of claim 17, further comprising configuring the virtualizing and obfuscating communications firmware module to be measured by immutable firmware.

24. The method of claim 17, further comprising verifying the virtualizing and obfuscating communications firmware module to be valid by using one or more measurement parameters.

25. The method of claim 24, wherein the one or more measurement parameters comprise at least one of a cryptographic key and a certificate within the portable device hardware.

26. The method of claim 17, wherein the virtualizing and obfuscating communications firmware module is configured to be verified to be valid prior to executing the virtualizing and obfuscating communications firmware module.

27. The method of claim 17, wherein the virtualizing and obfuscating communications firmware module comprises one or more additional logical threads of execution that can be mapped to one or physical threads or cores.

28. The method of claim 27, further comprising executing the virtualizing and obfuscating communications firmware module concurrently with other portions of the at least one operating system to improve overall communications latency and system performance.

29. The method of claim 17, further comprising configuring the virtualizing and obfuscating communications firmware module to control and manage one or more sensors to enforce a policy in which the virtualized communications system is only made available when one or more sensor readings are within an acceptable range of values.

30. The method of claim 29, wherein one or more sensors comprise at least one Global Positioning Satellite peripheral.

31. The method of claim 29, wherein the one or more sensor readings obtained by the virtualizing and obfuscating communications firmware module are resistant to corruption by the main operating system.

32. The method of claim 29, wherein the one or more sensor readings are provided by at least one of a Global Positioning Service, a cellular signal, and another location-based services.
